(19) United States
(12) Patent Application Publication
(10) Pub. No.: US 2015/0140237 A1
(43) Pub. Date: May 21, 2015

(54) Receiving Layer for Digital Printing Methods Having Nanofibrillated Cellulose

(71) Applicant: Schoeller Technocell GmbH & Co. KG, Osnabruck (DE)

(72) Inventors: Wolfgang Schmidt, Georgsmarienhutte (DE); Gerd Papier, Kurten (DE); Michael Schlenstedt, Dresden (DE); Ralf Gericke, Holzkirchen (DE); Andreas Fehlker, Osnabruck (DE)

(73) Assignee: Schoeller Technocell GmbH & Co. KG, Osnabruck (DE)

(21) Appl. No.: 14/407,586

(22) PCT Filed: Jun. 14, 2013
(86) PCT No.: PCT/EP2013/062392

§ 371 Date: Dec. 12, 2014

(30) Foreign Application Priority Data
Jun. 15, 2012 (DE) 10 2012 011 774.4

(51) Int. Cl. B41M 5/52

(52) U.S. Cl. CPC B41M 5/5236; B41M 5/5254
USPC 428/32.34; 428/32.1

(57) ABSTRACT

A recording material for the ink-jet printing process with a carrier and at least one colour-receiving layer arranged on the carrier in the colour-receiving layer, containing a nanofibrillated cellulose and demonstrating an improved cracking behaviour in the image layer.

### TECHNICAL FIELD OF THE INVENTION

The invention relates to recording material for digital printing processes having a carrier and a colour-receiving layer arranged on the carrier. The work, which led to the invention, was sponsored by the Seventh Framework Programme of the European Union [FP7/2007-2013]) under the Grant Agreement No. 22802.

### TECHNICAL BACKGROUND OF THE INVENTION

Digital printing processes include, among others, the ink-jet printing process. This printing process is also used for the high-quality printing of photos. So that an image quality, as in silver salt photography, is achieved, considerable demands are made on the recording materials for the ink-jet printing process. The applied inks must dry quickly, for which a high absorption capacity for the fluid ink is required. The ink dyes are to be fixed by the colour-receiving layer, that is, they are to be held such, that even when subjected to humidity they can no longer migrate or become detached from the colour-receiving layer. A high colour density is desirable. The paper must have a high light fastness, i.e. a high resistance to discolouration on exposure to light. In addition, the dimensional stability of the image medium should be high and the material should have good running properties in the printer. Finally, a smooth and possibly shiny surface is desirable.

Another quality characteristic is that crack formation in the image layer is avoided as far as possible. The cracking depends heavily on the drying process after applying the receiving layer, after printing with ink or a remoistening of the colour-receiving layer on the carrier. An increase of the layer thickness also seems to correlate with increased crack formation. A larger layer thickness of the colour-receiving layer, in particular above 20 μm, is however desirable for complete absorption of the ink in ink-jet printing.

To reduce crack formation, U.S. Pat. No. 6,372,329 B1 describes an ink-jet recording material for imaging with dyes and pigmented inks, in which on a substrate a first and a second ink-receiving layer are applied and in which the second ink-receiving layer contains a mixture consisting of a polyvinyl alcohol modified with maleic acid or itaconic acid and a plasticizer. The second layer is applied to the first layer. Phosphates, substituted phthalic anhydrides, glycerols and glycols, are named as plasticizers. The pH-value of the second layer composition should preferably be no greater than 4.0.

US 2002/0064633 A1 describes a receiving material for the ink-jet printing process for aqueous, oily and solid inks. The receiving layer contains a polymer and a cross-linking agent. The polymer comprises a quaternary ammonium in the molecule. In addition, a specific ratio of organic proportion to inorganic proportion is necessary in this polymer.

### SUMMARY OF THE INVENTION

The problem underlying the invention can be seen in providing a recording material for digital imaging methods, in particular for the ink-jet printing process, which, in addition to the usual requirements, such as high colour density, dimensional stability and photo-like haptics, exhibits a special strength against crack formation in the receiving layer.

This problem is solved by a recording material for digital printing processes with a carrier and at least one colour-receiving layer arranged on the carrier with a binder, wherein the colour-receiving layer contains a nanofibrillated cellulose (NFC).

Nanofibrillated celluloses within the meaning of the invention include celluloses with the designations microfibrillated cellulose (MFC), nanocrystalline cellulose and bacterial nanocellulose (BNC). The fibres of such nanofibrillated celluloses have a diameter in the nanometer range (nm). The length of the fibres can be up to a few micrometres (μm).

In particular, the use, according to the invention, of nanofibrillated celluloses in the colour-receiving layer permits the increase of the coating speed with the same layer thickness of the print receiving layer compared to traditional compositions of receiving layers for digital printing processes.

Surprisingly, it was also determined that the recording materials according to the invention had even further improved properties in the so-called cutting dust test and an improved water resistance of the print.

### DETAILED DESCRIPTION OF THE PREFERRED EMBODIMENTS OF THE INVENTION

The nanofibrillated celluloses used according to the invention can be obtained by the known pulping process, for example with a mixture of sodium hydroxide and sodium sulphide (kraft pulp) or salts of sulphurous acid (sulphite pulp), subsequent delamination of the pulp by chemical treatment such as the introduction of charged groups into the cellulose fibres and a subsequent homogenizing treatment of the pulp.

According to a preferred embodiment of the invention, pulp obtained after pulping can be oxidatively decomposed by treatment with 2,2,6,6-Tetramethyl piperidine-1-oxyl (TEMPO) and then mechanically homogenized. This oxidative treatment facilitates the defibrillation of the cellulose-containing material on subsequent mechanical homogenization. Nanofibrillated cellulose is ultimately obtained by the mechanical homogenization.

The defibrillation (delamination, homogenization) can be carried out by different processes. For this purpose, so-called microfluidizers, high performance grinders, combinations of beating, grating and homogenizing, high-shear mixers and cryogenic shredders are described. Nanocelluloses can also be obtained by delamination with ball mills and ultrasonic treatment.

These processes are for example described in Angew. Chem. 2011, 123, 5550-5580, in Biomacromolecules, Vol. 7, No. 6, 2006 1687-1691, in Adv. Eng. Mater. 2005, 7, 1156-1160 and in BioRessources 2006, 1, 176-188 with further literature references. Nanofibrillated celluloses are commercially available.

The fibre diameter of the fibres used according to the invention can be 3 to 100 nm, in particular 5 to 60 nm or 10 to 30 nm. The fibre length of the fibres used according to the invention can be 100 nm or 200 nm to 800 nm, 1 μm or a few μm. The fibre length can vary depending on the pulp used and the production process.

Preferably, the nanofibrillated cellulose in the coating compound for the receiving layer is in a concentration of from 0.01 to 1%, particularly preferable from 0.02 to 0.5% and most preferably from 0.04 to 0.08 wt. %, based on the dry weight of the coating compound used.

According to a further preferred embodiment, the nanofibrillated cellulose is freshly used. Fresh means within a period of two weeks following the date of manufacture of the nanofibrillated cellulose.

The receiving layer contains a water-soluble and/or water-dispersible binder. Suitable binders are for example polyvinyl alcohol, fully or partially saponified polyvinyl alcohol, cationic modified polyvinyl alcohol, polyvinyl alcohol having silyl groups, polyvinyl alcohol having acetal groups, gelatine, polyvinyl pyrrolidone, starch, carboxymethyl cellulose, polyethylene glycol, styrene/butadiene latex, acrylate copolymers such as styrene/acrylate latex, vinyl acetate homo- and copolymers and ethylene vinyl acetate copolymers. Particularly preferred are fully or partially saponified polyvinyl alcohols. The amount of binder can range from 60 to 5 wt. %, preferably from 50 to 10 wt. %, but in particular from 35 to 8 wt. %, based on the weight of the dried layer.

The receiving layer according to the invention (image recording layer) may also contain one or more pigments and at least one binder. Because during the application of the carrier materials with a synthetic resin layer, the synthetic resin layer has a barrier effect for the ink and the base paper cannot accommodate the ink, the recording layer/s applied thereto must have a high absorption capacity, which can be achieved, for example, by the use of highly absorptive inorganic particles. Such microporous layers provide a high ink absorption capacity.

Suitable pigments are, for example, aluminium oxide, aluminium hydroxide, aluminium oxide hydroxide, aluminium oxide hydrate, silica, magnesium hydroxide, kaolin, titanium dioxide, zinc oxide, zinc hydroxide, calcium silicate, magnesium silicate, calcium carbonate, magnesium carbonate and barium sulphate. The quantity of the pigment in the receiving layer can be from 40 to 95 wt. %, preferably from 60 to 90 wt. %, based on the weight of the dried layer.

The particle size distribution of the pigment of the receiving layer can preferably be less than 1000 nm, but in particular 50 to 150 nm. The mean particle size of the primary particles is preferably less than 100 nm, in particular less than 50 nm. Such particle sizes of the pigment are suitable for shiny surfaces. Should the image be matt, pigments having a particle size of 1 μm to 10 μm can be used in the receiving layer.

The receiving layer can contain usual additives and aids such as cross-linking agents, ionic and/or non-ionic surfactant substances, dye-fixing agents such as polyammonium compounds, UV-absorbers, antioxidants and other agents improving light stability and gas resistance as well as other aids.

The coating weight of the ink-receiving layer may be from 5 to 60 g/m², preferably 10 to 50 g/m², particularly preferably from 20 to 40 g/m².

The receiving layer can be single-layered or multi-layered. In a special embodiment of the invention the receiving layer can be constructed from an ink-absorbing lower layer and a dye-fixing upper layer.

According to the invention, suitable pigments of the ink-absorbing lower layer are then, for example, aluminium oxide, aluminium hydroxide, aluminium oxide hydroxide, aluminium oxide hydrate, silicon dioxide, silica, barium sulphate and titanium dioxide. In the lower layer a pigment on the basis of aluminium oxide and/or aluminium oxide hydroxide is particularly preferred. Such a pigment can be cationically modified. The concentration of the pigment in the ink-absorbing layer is from 40 to 95 wt. %, preferably about 60 to 90 wt. %, based on the weight of the dried layer.

The particle size distribution of the pigment of the ink-absorbing layer can preferably be in the range of from 70 to 1000 nm, preferably 80 to 200 nm, particularly preferably from 90 to 150 nm. The mean particle size of the pigment of the ink-absorbing layer can be 50 to 350 nm, preferably 80 to 120 nm.

According to the invention, suitable pigments of the dye-fixing layer are, for example, aluminium oxide, aluminium hydroxide, aluminium oxide hydrate, silicon dioxide, barium sulphate and titanium dioxide. The concentration of the pigment in the dye-fixing layer can be from 70 to 95 wt. %, preferably 80 to 90 wt. %.

The particle size distribution of the pigment of the dye-fixing layer can preferably be in the range of from 50 to 200 nm, preferably 70 to 120 nm. The mean particle size of the pigment of the dye-fixing layer can preferably be 70 to 120 nm, in particular 100 nm. For matt surfaces the pigments can have a particle size of 1 μm to 10 μm.

The ink-absorbing and the dye-fixing layer contain a water-soluble and/or water-dispersible polymeric binder. Suitable binders are for example polyvinyl alcohol, fully or partially saponified polyvinyl alcohol, cationic modified polyvinyl alcohol, polyvinyl alcohol having silyl groups, polyvinyl alcohol having acetal groups, polyvinyl alcohol having acetate groups, gelatine, polyvinyl pyrrolidone, starch, carboxymethyl cellulose, polyethylene glycol, styrene/butadiene latex and styrene/acrylate latex. The amount of the binder in the dye-fixing layer and the ink-absorbing layer is from 5 to 45 wt. %, respectively, preferably 10 to 35 wt. %, based on the weight of the dried layer.

Both layers can contain usual additives and aids such as tensides, cross-linking agents and dye-fixing agents.

The application weights of the ink-absorbing and the dye-fixing layer can be 10 to 60 g/m², respectively, preferably 15 to 30 g/m².

The receiving layer can be applied on the carrier by, for example, a doctor knife method, blade method, film press, airbrush, the so-called slot die process or a curtain coating process.

In a further embodiment of the invention, on the receiving layer further layers such as protection layers or gloss-improving layers can be applied. The coating weight is preferably less than 1 g/m².

As a carrier for the receiving layer according to the invention, a base paper, a synthetic resin-coated paper or a plastic film can be used.

For the purposes of the invention, by the term base paper an uncoated or surface sized paper is meant. Apart from cellulose fibres, a base paper can contain sizing agents such as alkylketene dimers, fatty acids and/or fatty acid salts, epoxydized fatty acid amides, alkenyl or alkyl succinic anhydride, starch, tree gums, wet-strengthening agents such as polyamine polyamide epichlorohydrin, dry strength agents such as anionic, cationic or amphoteric polyamides, optical brighteners, pigments, dyes, anti-foaming agents and other aids known in the paper industry. The base paper can be surface size paper. In this respect, appropriate sizing agents are for example polyvinyl alcohol or oxidized starch. The base paper can be manufactured on a Fourdrinier or Yankee paper machine (cylinder paper machine). The surface weight of the base paper can be 50 to 250 g/m², in particular 80 to 180 g/m². The base paper can be used in a non-compressed or compressed form (smoothed). Base papers having a density of from 0.8 to 1.05 g/cm³, in particular 0.95 to 1.02 g/cm³, are particularly preferred.

For the paper manufacture, all types of pulp usual for this purpose can be used. The pulp for the manufacture of the paper is preferably a eucalyptus pulp with a proportion of fibrous material smaller than 200 μm after grinding of from 10 to 35 wt. % and having an average fibre length of 0.5 to 0.75 mm. It has been shown that the use of a pulp with a limited proportion of fibres smaller than 200 μm lowers the loss of stiffness occurring when using fillers. Hardwood pulps (NBHK—Northern Bleached Hardwood Kraft Pulp) and coniferous pulps can also be used.

As fillers for the sheet production, kaolins, calcium carbonate in its natural form, such as limestone, marble or dolomite, precipitated calcium carbonate, calcium sulphate, barium sulphate, titanium dioxide, talc, silica, alumina and mixtures thereof can, for example, be used in the base paper. Calcium carbonate having a particle size distribution, in which at least 60% of the particles are smaller than 2 μm and at the most 40% smaller than 1 μm, is preferred. In a particular embodiment of the invention, calcite is used with a particle size distribution of approximately 25% of the particles having a particle size of less than 1 μm and about 85% of the particles having a particle size of less than 2 μm. According to a further embodiment of the invention, a calcium carbonate having a particle size distribution can be used, in which at least 70%, preferably at least 80%, of the particles are smaller than 2 μm and at the most 70% of the particles are smaller than 1 μm.

In a further preferred embodiment of the invention the carrier can be paper coated with synthetic resin. A synthetic resin-coated paper contains a synthetic resin layer arranged on at least one side of the base paper. The synthetic resin layer can preferably contain a thermoplastic polymer. Particularly suitable for this purpose are polyolefins, in particular low density polyethylene (LDPE), high density polyethylene (HDPE), ethylene/α-olefin copolymers (LLDPE), polypropylene, polyisobutylene, polymethylpentene and mixtures thereof. But also other thermoplastic polymers, such as (meth)acrylic acid ester homopolymers, (meth)acrylic acid ester copolymers, vinyl polymers such as polyvinyl butyral, polyamides, polyesters, polyacetals, polylactic acids (PLA) and/or polycarbonates can be used.

The synthetic resin layer can contain white pigments such as titanium dioxide and calcium carbonate as well as other additives such as optical brighteners, dyes and dispersing agents. The coating weight of the synthetic resin layer on the front can be 5 to 50 g/m², in particular 10 to 30 g/m² or according to a further preferred embodiment 10 to 20 g/m². The synthetic resin layer can be extruded in a single layer or co-extruded in multi-layers. The extrusion coating can be carried out with machine speeds up to 600 m/min.

In a preferred embodiment of the invention, the back of the base paper may be coated with a clear, i.e. pigment-free synthetic resin, in particular polyethylene. The coating weight of the synthetic resin layer on the back can be 5 to 50 g/m², in particular 10 to 40 g/m² or according to a further preferred embodiment 10 to 20 g/m². The synthetic resin layer on the back of the base paper can however also be pigmented.

The back of the layer carrier can also have further functional layers such as antistatic or anti-curl layers.

Between the base paper and synthetic resin layer a layer can be arranged containing a hydrophilic binder. Particularly suitable for this purpose are film-forming starches. Hydrophilic binders are for example hydroxypropylated starches and/or thermally modified starch. This layer can preferably contain further polymers such as polyamide copolymers and/or polyvinylamine copolymers.

The base paper can however also have a size press coating with a binder, wherein the applied quantity is 0.3 to 5 g/m². Suitable binders are usual surface sizing agents and polyacrylates. This coating can contain pigments. In addition to or instead of the size press coating a layer with pigment can be applied.

The layer containing the hydrophilic binder can be arranged directly on the front of the base paper or on the back of the base paper. It can be applied as a single layer or as multi-layers on the base paper. The coating compound can be applied inline or offline with all of the usual appliances used in paper manufacturing, wherein the amount is selected such that after drying the coating weight per layer is at the most 20 g/m², and in particular 8 to 17 g/m², or according to a particularly preferred embodiment 2 to 6 g/m².

The layer can preferably contain a pigment. The pigment can be selected from a group of metal oxides, silicates, carbonates, sulphides and sulphates. Pigments such as kaolins, talc, calcium carbonate and/or barium sulphate are particularly suitable. Particularly preferred is a pigment with a narrow particle size distribution in which at least 70% of the pigment particles have a size less than 1 μm. In order to achieve the effect according to the invention, the amount of the pigment with the narrow particle size distribution of the total pigment amount should be at least 5 wt. %, in particular 10 to 90 wt. %. Particularly good results can be obtained with a proportion of 30 to 80 wt. % of the total pigment.

According to the invention, as a pigment with a narrow particle size distribution, also pigments with a particle size distribution are considered in which at least 70 wt. % of the pigment particles have a size smaller than 1 μm and in 40 to 80 wt. % of these pigment particles, the difference between the pigment with the largest grain size (diameter) and the pigment of the smallest grain size is smaller than about 0.4 μm. It was found that a calcium carbonate with a d₅₀% value of about 0.7 μm was particularly advantageous.

In a particular embodiment of the invention a pigment mixture was used, composed of the above-mentioned calcium carbonate and kaolin. The ratio of calcium carbonate/kaolin is preferably 30:70 to 70:30. Surprisingly, it was found that, in spite of the high proportion of kaolin, which tends to yellow, only a minor negative impact on the whiteness of the coated material was observed.

The ratio of the mass of binder/pigment in the layer may be 0.1 to 2.5, preferably 0.2 to 1.5, in particular however 0.9 to 1.3.

The solid content of the coating compound according to the invention can be 15 to 35 wt. %, based on the weight of the coating compound.

In a further embodiment of the invention a synthetic film can be used as carrier. Synthetic films, suitable as carriers, are those such as of polyolefin/s, poly carbonates, acrylic resin/s, polyvinyl chloride and polyethylene terephthalate.

The colour-receiving layer can contain an electrically conductive component. For example, suitable electrically conductive components are an electrically conductive polymer or fine-particle electrically conductive pigments. The amount of the electrically conductive components in the colour-receiving layer can be from 0 to 50 wt. %, in particular 0.1 to 4.0 wt. %, based on the compound of the dried layer.

The following examples serve to further explain the invention.

### EXAMPLES

### Example 1

### Manufacture of Nanofibrillated Cellulose

Starting from a sulphite pulp of the company Domsjö Fabriker AB, Sweden, the manufacture of nanofibrillated cellulose took place via the so-called TEMPO oxidation and subsequent mechanical homogenization. A tank with a capacity of 500 l was filled with the following substances:

50 kg pulp suspension (solid content 3.5%)

10 g TEMPO (2,2,6,6-Tetramethyl-piperidine-1-oxyl)

1.65 kg NaBr

21 l NaOCl (150 g/l).

The pulp was at first disintegrated in water for 15 minutes. TEMPO and sodium bromide from a prepared mixture was added and then the sodium hypochlorite was added and the mixture was left for two hours in the tank at a pH-value around 10. The pH-value was set with 1 M NaOH. The reaction was stopped with the addition of ethanol, which reacted with the remaining hypobromite. After the reaction the functionalized pulp was washed four times and centrifuged.

Under these conditions three master batches were produced. The carboxyl group content in the master batch 1 was 1.19 mmol/g, in the master batch 2 0.92 mmol/g and in the master batch 3, 1.12 mmol/g.

After the manufacture of chemically modified fibres, the TEMPO fibres for the manufacture of nanofibrillated cellulose were used. The product to be homogenized was treated at a consistency of the product of 4% in a GEA Ariete homogenizer in two cycles at 150 MPa (1500 bar).

### Example 2

### Manufacture of a Carrier

For the manufacture of the base paper a eucalyptus pulp was used. For grinding, the pulp was ground as an aqueous suspension of about 5% (high consistency) with the aid of a refiner at a grinding degree of 36° SR. The mean fibre length was 0.64 mm. The concentration of the pulp fibres in the low consistency material was 1 wt. % in relation to the compound of the pulp suspension. Additives were added to the low consistency material such as a neutral sizing agent alkylketene dimer (AKD) in an amount of 0.48 wt. %, wet-strength agent polyamine polyamide epichlorohydrin resin (Kymene®) in an amount of 0.36 wt. % and a natural CaCO₃ in an amount of 10 wt. %. The quantity data relate to the mass of pulp.

The low consistency material, the pH-value of which was set at about 7.5, was brought from the headbox to the screen of the paper machine whereby the sheet formation was carried out under drainage of the web in the screen section of the paper machine. In the press section the further drainage of the paper web was carried out at a moisture content of 60 wt. %, based on the web weight. Further drying was carried out in the dry section of the paper machine with heated drying cylinders. Base paper was created with a surface weight of 160 g/m² and a humidity of about 7%.

The paper was coated with a coating compound of a styrene-acrylic binder, starch and a pigment mixture of calcium carbonate and kaolin with a coating weight of 15 g/m², respectively, on both sides, dried and then smoothed with a calender.

### Example 3

### Coating the Base Paper with a Synthetic Resin

The back of the base paper was coated with a pigment-free synthetic resin mixture of 40 wt. % of a low-density polyethylene (LDPE, d=0.923 g/cm³) and 60 wt. % of a high-density polyethylene (HDPE, d=0.964 g/cm³) in a laminator at an extrusion speed of 250 m/min. The thickness of the layer was 17 μm.

The front of the base paper was coated with a synthetic resin mixture of 71 wt. % of a low-density polyethylene (LDPE, 0.923 g/cm³), 16 wt. % of a TiO₂ master batch (50 wt. % LDPE and 50 wt. % TiO₂) and 13 wt. % further additives such as optical brighteners, calcium stearate and blue pigments with a coating weight of about 17 g/m² in the laminator at a speed of 250 m/min. The thickness of the front synthetic resin layer was 17 μm. On the front synthetic resin layer a receiving layer for the ink-jet printing process was then applied.

### Example 4

### Manufacture of a Coating Compound for the Colour-Receiving Layer

For a comparison of the crack formation behaviour (cracking) of the various coating compounds a uniform solid content of the coating compounds is necessary. Furthermore, the nanocellulose must be diluted for good processability. Therefore, both celluloses, before manufacture of the coating compounds, were diluted to a uniform solid content of 2%.

To provide a preliminary evaluation of the coating compounds, the dilutions of nanofibrillated cellulose in which the planned compositions for the pilot coating test were used according to the standard conditions for coating colour compositions based on aluminium oxide.

The following Table shows an overview of the formulations used, as well as the test values after manufacture in the laboratory.

Test

| Raw material | Standard | NFC-TE |
|---|---|---|
| Pigment | 100 | 100 |
| Hardener | 0.35 | 0.35 |
| PVA Mowiol ® 4088 | 11 | 11 |
| Nanocellulose | 0 | 0.06 |
| Wetting agent | 0.03 | 0.03 |

Fresh:

| | | |
|---|---|---|
| Solid content (%) | 27.69 | 27.61 |
| Viscosity (mPas) | 164 | 164 |
| pH value | 4.48 | 4.48 |
| Surface tension | 37 | 37 |

After 3 h:

| | | |
|---|---|---|
| Viscosity (mPas) | 202 | 165 |
| pH-value | 4.48 | 4.49 |
| Surface tension | 32 | 34.5 |

After 20 h:

| | | |
|---|---|---|
| Viscosity (mPas) | 238 | 190 |
| pH-value | 4.55 | 4.56 |
| Surface tension | 32 | 34 |

NFC stands for nanofibrillated cellulose. TE is the treatment after the TEMPO process.

Test of the Coating Mass

In the test of the coating with the coating compounds according to the invention in a pilot coating test, the potential for an increase in speed when using nanofibrillated cellulose was to be determined. The quality criterion in this case was the cracking level. The process settings were therefore chosen in such a way that, also in the standard formulation a certain degree of cracking already occurs, in order to subsequently be able to better compare the nanofibrillated cellulose with the standard. Subsequently, the coating weight of the compositions with nanofibrillated cellulose with a constant drying profile was gradually increased and the cracking level was compared to the standard, respectively. Via the possible increase in the coating weight, the potential for an increase in speed with a constant drying profile can be estimated.

The following Table shows an overview of the test values after manufacture in the pilot scale.

Test

| Raw material | Standard | NFC-TE |
|---|---|---|
| Pigment | 100 | 100 |
| Hardener | 0.35 | 0.35 |
| PVA | 11 | 11 |
| Nanocellulose | 0 | 0.06 |
| Wetting agent | 0.03 | 0.03 |

Fresh:

| | | |
|---|---|---|
| Solid content (%) | 27.39 | 27.30 |
| Viscosity (mPas) | 174 | 164 |
| pH-value | 4.66 | 4.7 |
| Surface tension | 40 | 39 |

The compositions with nanofibrillated cellulose showed no abnormalities during the test run while coating the carrier by means of curtain coating. There were no differences between the individual compositions regarding curtain stability or operating performance during casting.

For the evaluation, the samples with the nanofibrillated cellulose as the best possible variants, were used. The cracking level was determined in two ways:
By counting the cracks in a total of three circles with a surface of 1 cm² twice enlarged,
visually on the light table (oblique illumination/neon tube) by awarding scores according to the school marking principle.

In particular on increasing cracking levels, the counting method becomes very uncertain, because partially not the number of cracks but the size increased enormously and thus also a fewer number of cracks can generate a specimen completely traversed with cracks. For this reason, the visual assessment of the sample quality was included in the evaluation.

The results are shown in Table 5. A considerable difference between the standard and the samples with nanofibrillated cellulose can be seen. The formulation with nanocellulose shows a considerably improved cracking level as opposed to the formulation without nanofibrillated cellulose (cf. VT1.1 and 2.1). With increasing coating weight, the cracking level increases as expected. The level of the comparison is reached between +2 and +4 gm².

This corresponds to a potential for an increase in speed of 5 to 10%. The following Table shows the results.

| | Mix | cwt | | Microcracking | | | | | |
|---|---|---|---|---|---|---|---|---|---|
| Test | potential | [g/m²] | Speed | Circle | 1 | 2 | 3 | Total Score | Comment |
| VT1.1 | Standard | 40 | +0% | 56 | 49 | 40 | 145 | 4 | Comparison; standard |
| VT2.1 | with | 40 | +0% | 27 | 21 | 26 | 74 | 2 | |
| VT2.2 | NFC-TE | 42 | +5% | 31 | 42 | 42 | 115 | 3− | |
| VT2.3 | | 44 | +10% | 31 | 37 | 42 | 110 | 5 | Large cracks, counting method not |
| | | | | | | | | | significant |
| VT2.4 | | 46 | +15% | 33 | 41 | 48 | 122 | 6 | Large cracks, counting method not |
| | | | | | | | | | significant |

| | | | | |
|---|---|---|---|---|
| VT2.5 | 48 | +20% | completely cracked | 6 |
| VT2.6 | 50 | +25% | | 6 |
| VT2.7 | 52 | +30% | | 6 |

Cwt: Coating weight

The paper property of cutting dust was consequently determined.

Cutting dust—The samples with nanocellulose have an improved formation of cutting dust compared with the standard. However, altogether all samples are on a very low and good level, as the following Table shows.

| | Glass - empty | Glass + cutting | Result | Cutting dust |
|---|---|---|---|---|
| | [g] | dust × 50 [g] | [g] | [mg] |
| PiCo VT 0.5 | 5.859 | 5.864 | 0.005 | 5 |
| PiCo VT | 5.581 | 5.583 | 0.002 | 2 |
| PiCo VT | 5.638 | 5.639 | 0.001 | 1 |

1. Recording material for the ink-jet printing process comprising a carrier and at least one colour-receiving layer containing a binder arranged on the carrier, wherein the colour-receiving layer comprises a nanofibrillated cellulose.

2. Recording material according to claim 1, wherein the proportion of the nanofibrillated cellulose in the colour-receiving layer is 0.02 to 0.1 wt. %, related to the dry weight of the layer.

3. Recording material according to claim 1, wherein the colour-receiving layer contains a water-soluble and/or water-dispersible binder.

4. Recording material according to claim 1, wherein the colour-receiving layer contains a polyvinyl alcohol.

5. Recording material according to claim 1, wherein the colour-receiving layer contains a fine inorganic pigment.

6. Recording material according to claim 1, wherein at least one side of the carrier is provided with a polyolefin layer and the polyolefin layer is arranged on the front side between the carrier and the colour-receiving layer.

7. Recording material according to claim 6, wherein the colour-receiving layer comprises a nanofibrillated cellulose in an amount of 0.02 to 0.1 wt. %, related to the dry weight of the colour-receiving layer.
